(19) United States
(12) Patent Application Publication
(10) Pub. No.: US 2012/0006133 A1
(43) Pub. Date: Jan. 12, 2012

(54) LOW ROW STEAM GENERATOR INSPECTION PROBE

(75) Inventors: Jeffrey Bishop Draper, McVeytown, PA (US); Matthew Barton Wolf, Boalsburg, PA (US); Michael Alphonse Terhaar, Lewistown, PA (US); Lance Edmund Maggy, Mount Pleasant, SC (US)

(73) Assignee: General Electric Company, Schenectady, NY (US)

(21) Appl. No.: 13/030,484

(22) Filed: Feb. 18, 2011

Related U.S. Application Data
(60) Provisional application No. 61/363,554, filed on Jul. 12, 2010.

(51) Int. Cl. G01D 21/00

(52) U.S. Cl. 73/866.5

(57) ABSTRACT

An inspection assembly for insertion inspection of an elongate tubular member. The inspection assembly includes a probe head with a sensor. The assembly also includes a flexible shaft connected to the probe head and transmitting a motive force to the probe head to move the probe head within the elongate tubular member. The probe head includes at least one characteristic to minimize resistance against movement of the probe head along a torturous path within the tubular member.

### CROSS REFERENCE TO RELATED APPLICATION

The present application is a continuation of U.S. Provisional Patent Application No. 61/363,554, filed Jul. 12, 2010, which is incorporated herein by reference.

### BACKGROUND OF THE INVENTION

1. Field of Invention

The present invention relates to internal inspection probes for inspecting tubular members, such as tubular member present within nuclear steam generator.

2. Discussion of Prior Art

Use of inspection/detection devices, such as eddy current sensors, is known. Such devices can be used, for example, for nuclear generator tubular members with tortuous bends (e.g., u-bends). However, it is possible know devices to become lodged, or otherwise not able to proceed along the tubular member such that further inspection is not possible. Thus there is a need for improvements to avoid such issues.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides an inspection assembly for insertion inspection of an elongate tubular member. The inspection assembly includes a probe head including at least one sensor for sensing a characteristic of the elongate tubular member as the probe head is moved internally within the elongate tubular member, the sensor including at least one wire winding. The assembly includes a flexible shaft connected to the probe head and transmitting a motive force to the probe head to move the probe head within the elongate tubular member. The probe head includes a flexible tube, a probe body supporting the sensor and mounted upon the flexible tube, and at least one centering bead mounted upon the flexible tube, the probe body including a center section supporting the at least one wire winding, and the probe body including at least one characteristic to minimize resistance against movement of the probe head along a torturous path within the tubular member.

In accordance with another aspect, the present invention provides an inspection assembly for insertion inspection of an elongate tubular member. The inspection assembly includes a probe head including at least one sensor for sensing a characteristic of the elongate tubular member as the probe head is moved internally within the elongate tubular member, the sensor including at least one wire winding. The assembly also includes a flexible shaft connected to the probe head and transmitting a motive force to the probe head to move the probe head within the elongate tubular member. The probe head includes a flexible tube, a probe body supporting the sensor and mounted upon the flexible tube, and at least one centering bead mounted upon the flexible tube, with the probe body including a center section supporting the at least one wire winding, and the probe body including at least one truncated cone chamfer end adjacent to the center section.

In accordance with still aspect, the present invention provides an elongate tubular member. The inspection assembly includes a probe head that includes at least one sensor for sensing a characteristic of the elongate tubular member as the probe head is moved internally within the elongate tubular member, the sensor including at least one wire winding. The assembly also includes a flexible shaft connected to the probe head and transmitting a motive force to the probe head to move the probe head within the elongate tubular member, the shaft including at least one wire operatively connected between the sensor and at least one component external to the elongate tubular member for sensory operation of the sensor. The probe head includes a flexible tube, a probe body supporting the sensor and mounted upon the flexible tube, and at least one centering bead mounted upon the flexible tube, the probe body including a center section supporting the at least one wire winding, and the probe body being provided as two separable and attachable parts to allow access for direct attachment of the at least one wire to the at least one wire winding of the sensor.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematized illustration of an example inspection assembly in accordance with at least one an aspect of the present invention;

FIG. 2 is an illustration of an example of a nuclear steam generator having a plurality of tubular members that have at least one bend and within which the present invention may be utilized;

FIG. 3 is an illustration of torn-away portions of the inspection assembly of FIG. 1 that are within example torn-open portions of a tubular member of the generator of FIG. 2 and in accordance with at least one aspect of the present invention;

FIG. 4 is an enlarged view of a probe head of the inspection assembly of FIG. 1, and shows an exploded connection to a probe shaft of the inspection assembly;

FIG. 5 is an exploded view of a portion of the probe head of FIG. 4 and shows a two part probe body construction that has a hollow interior and providing direct connection of wires directly to a sensor on the probe body; and

FIG. 6 is an enlarged view of certain parts of the probe head of FIG. 4 and shows the interior of the body, with windings thereon and the direct connection of wires for location within the interior.

### DETAILED DESCRIPTION OF THE INVENTION

Illustrative embodiments that incorporate one or more aspects of the invention are described and illustrated in the drawings. These illustrated examples are not intended to be overall limitations on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

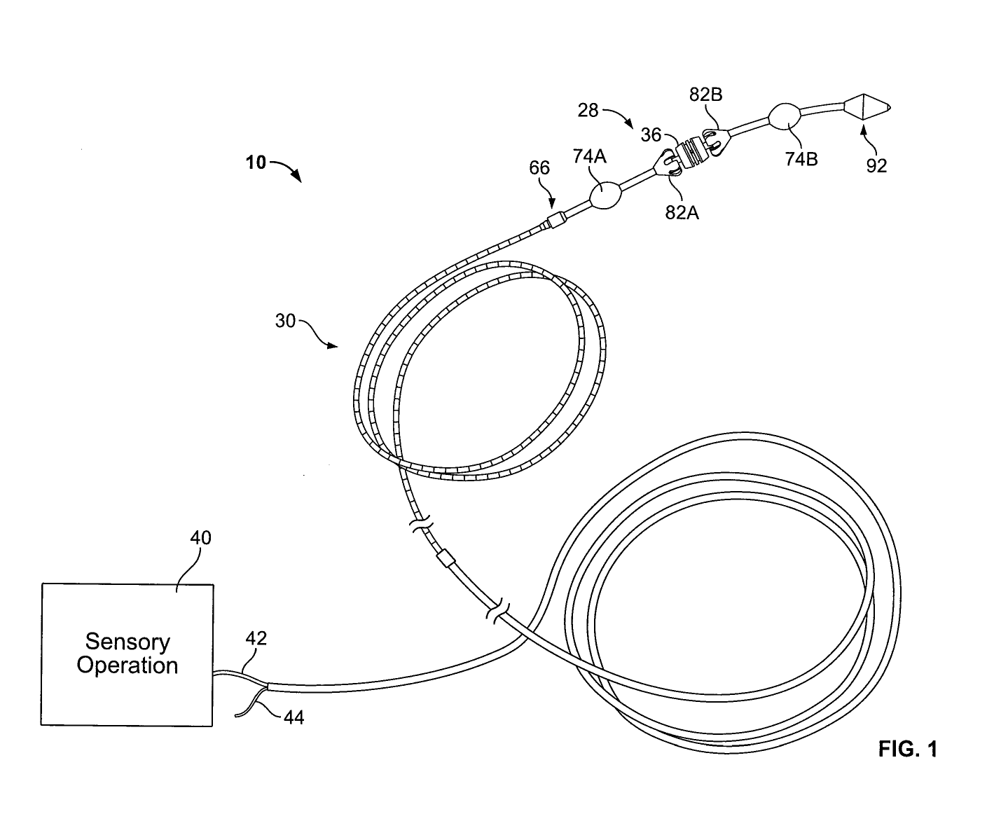

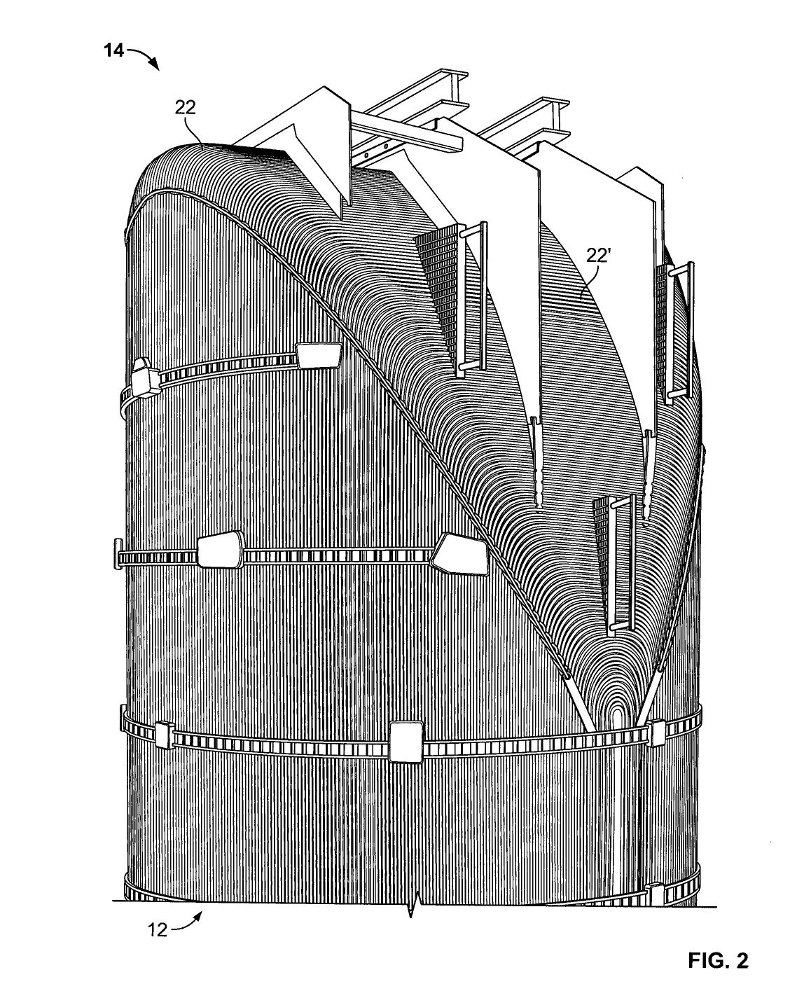

An example of an inspection assembly 10 in accordance with aspects of the present invention is schematically shown in FIG. 1. It is to be appreciated that the example is for illustrative purposes only and need not present specific limitations upon the scope of the present invention. The inspection assembly 10 is for insertion inspection of an elongate tubular member 12 (see for example, a tubular member shown within FIG. 2).

Turing briefly to FIG. 2 and the example tubular member 12 shown therein, the device shown in FIG. 2 is an example generator 14 within which the inspection assembly 10 of FIG. 1 may be utilized. The tubular member 12 may be part of a “Low Row” (2.0″ radius tube and greater) U-bend tube of the generator 14. The example generator 14 shown within FIG. 2 merely presents one example environment for the inspection assembly 10. It is to be appreciated that the present invention can be used in other environments (e.g., other tubular environments associated with different generators and other tubular environments that are not part of a generator). The generator 14 and numerous tubular members 12 (only one example tubular member 12 is identified with a reference number, however, any of the shown tubular members could be so identified).

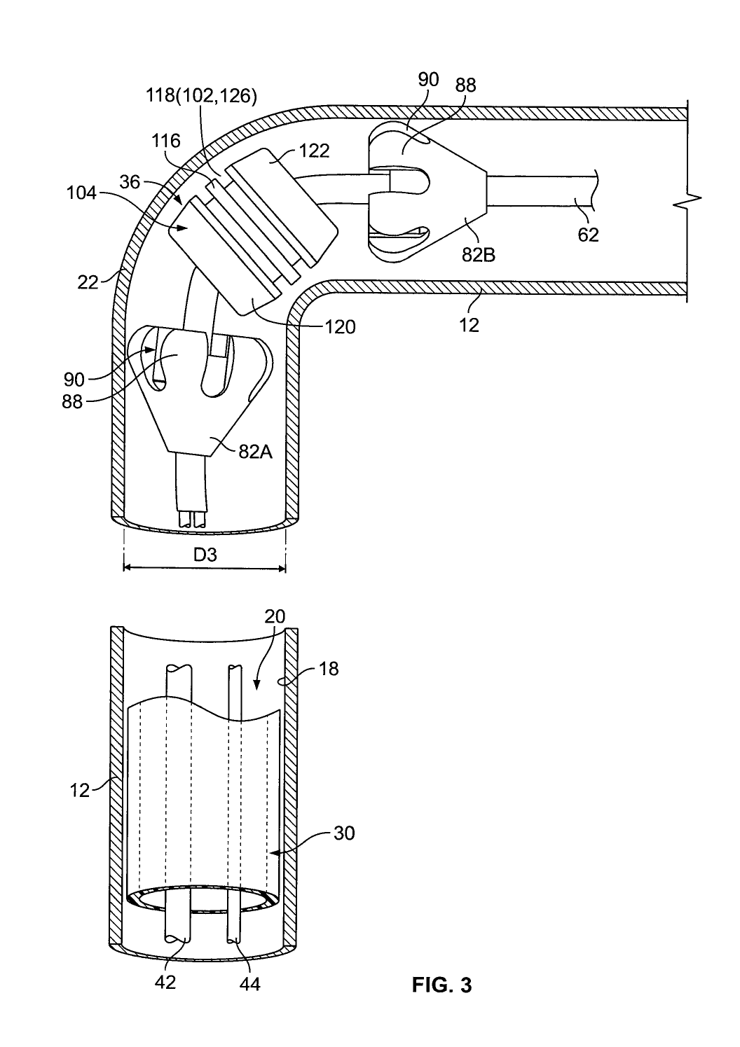

Focusing upon the tubular member 12, the tubular member is hollow and has a generally arcuate/rounded (e.g., circular or oval cross-section) interior surface 18 (see the example section of FIG. 3). The interior surface 18 of the tubular member 12 bounds an interior space 20 of the tubular member 12. In some specific examples the tubular member 12 is relatively long and has at least one bend 22 (the example bend shown in FIG. 1 is a transition between vertical and horizontal sections of the tubular member). In further specific examples, the tubular member 12 has multiple bends (e.g., 22′ shown within FIG. 2) and thus provides a tortuous path along its interior space 20. In at least one example, two bends 22, 22′ within the tubular member 12 provides the member with a U-bend configuration. The tubular member 12 can have a varied length. The at least one bend 22 and/or the length of the tubular member 12 can provide for a path within the tubular member that can be considered to be tortuous.

Focusing again upon the inspection assembly 10 (FIG. 1), the assembly is for inspection of the tubular member 12 (FIGS. 2 and 3) from the perspective of the interior space 20 of the tubular member 12. Such inspection may be in the form of sensing/testing/monitoring at least one condition of the tubular member 12 from the interior space 20 of the tubular member along the tubular member. The at least one condition need not be a specific limitation upon the present invention. The inspection assembly 10 (FIG. 1) includes a probe head 28 and a flexible probe shaft 30, with the probe head 28 connected to the probe shaft 30.

At least one sensor 36 (shown generically in FIG. 1) that senses/tests/monitors the at least one characteristic (e.g., a condition) of the tubular member 12 is located within/at the probe head 28. An example of characteristic (e.g., a condition) to be sensed/tested/monitored includes structural integrity (e.g., weakened portions) of the tubular member 12. Details of the presented example probe head 28 are presented below.

The probe head 28 is operatively connected to a sensory operation portion 40 (schematically represented as simply a box) of the inspection assembly 10 via at least one wire 42. To be clear, the wire(s) 42 may be a plurality of wires or provided a wiring bundle and referred to as simply a wire. Different wires within the plurality or bundle could accomplish different functions. The wire(s) 42 extends to be operatively connected to the probe head 28, extends along the length of the probe shaft 30, and extends to be operatively connected to the sensory operation portion 40. The wire(s) 42 are housed within an interior of the probe shaft 30 as described further following. Electrical power and/or electrical signals (e.g., control and/or sensory) are passed along the wire(s) 42 between the probe head 28 and the sensory operation portion 40.

In general, the probe head 28 of the inspection assembly 10 is moved along the interior space 20 of the tubular member 12 while the probe head 28 senses/tests/monitors. The sensory operation portion 40, via the wire connection to the probe head 28, provides power and/or control and receives sensory signals from the probe head 28 to make determination(s) about the sensed/tested/monitored at least one condition of the tubular member 12 as the probe head 28 is moved relatively along the tubular member. In is to be appreciated that the sensory operation portion 40 may contain any suitable structures to perform the functions, such as power source components, processing components (e.g., one or more microprocessors), data storage components, and communication components. The sensory operation portion 40 may be operatively connected to one or more external or intermediary components (not shown) for control of the sensory operation portion 40 and/or provision of the sensory information outside of the shown system and/or other operations.

As mentioned, the probe head 28, with its sensor(s) 36, is moved along the tubular member 12. The movement along the tubular member 12 is first inbound (e.g., inserting) relative to the tubular member 12 and is secondly outbound (e.g., extracting) relative to the tubular shaft. The motive force to move the probe head 28 along tubular member 12 is imparted via force applied to the probe shaft 30. In one example, the motive force is in the form of manual force applied to the probe shaft 30.

As mentioned, the probe shaft 30 houses the wire(s) 42 extending between the probe head 28 and the sensory operation portion 40. It is possible to consider the wire(s) 42 to be part of the probe shaft 30. Also, within the shown example, an optional non-metal cable 44 is provided as part of the probe shaft 30, and the cable is coupled to the probe head 28. The cable 44 is housed within the interior of the probe shaft 30 and can be considered to be part of the probe shaft. The cable 44 provides for the transmission of tensile force for extracting (i.e., pulling to retrieve) the probe head 28 from the tubular member 12. The cable 44 may be braided filament cordage. The use of non-metal material for the cable 44 helps to avoid imposing electrical interference to the wire(s) 42. Of course, a different construction/material may be used for the cable 44.

The probe shaft 30, with the included wire(s) 42 and cable 44, is flexible. The flexibility allows the probe shaft 30 to proceed along bends (e.g., 22, 22′) of the tubular member 12. Yet the probe shaft 30 has sufficient rigidity to allow insertion into the tubular member 12 and move the probe head 28 along the extent of the tubular member 12. The overall length of the probe shaft 30 may be any suitable length. However, within one example the length is sufficiently long to meet or exceed a length measured along the entire elongate extent of the tubular member 12. For such an example, the probe head 28 may be moved along the entire elongate extent of the tubular member via insertion movement of the probe shaft 30 into the tubular member 12. Recall that it is force applied to the probe shaft 30 that moves the probe head 28 along the insertion direction of the tubular member. It should be noted that the probe shaft 30 may include various features and such features need not be part of the present invention.

The probe head 28 also proceeds along the tubular member 12 and of course the bends (e.g., 22, 22′) of the tubular member 12 (see for example FIG. 3). The bends and/or the length of the tubular member 12 provide a tortuous path for the probe head 28. In accordance with one aspect, the probe head 28 has at least one characteristic or feature to minimize resistance against movement of the probe head along a torturous path within the tubular member.

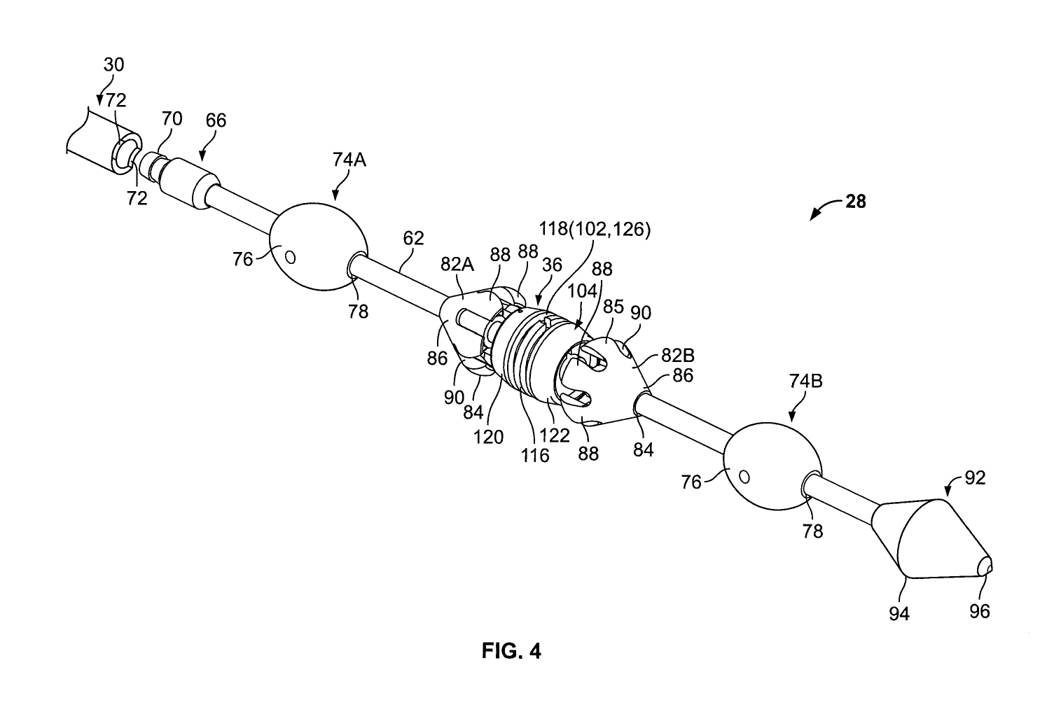

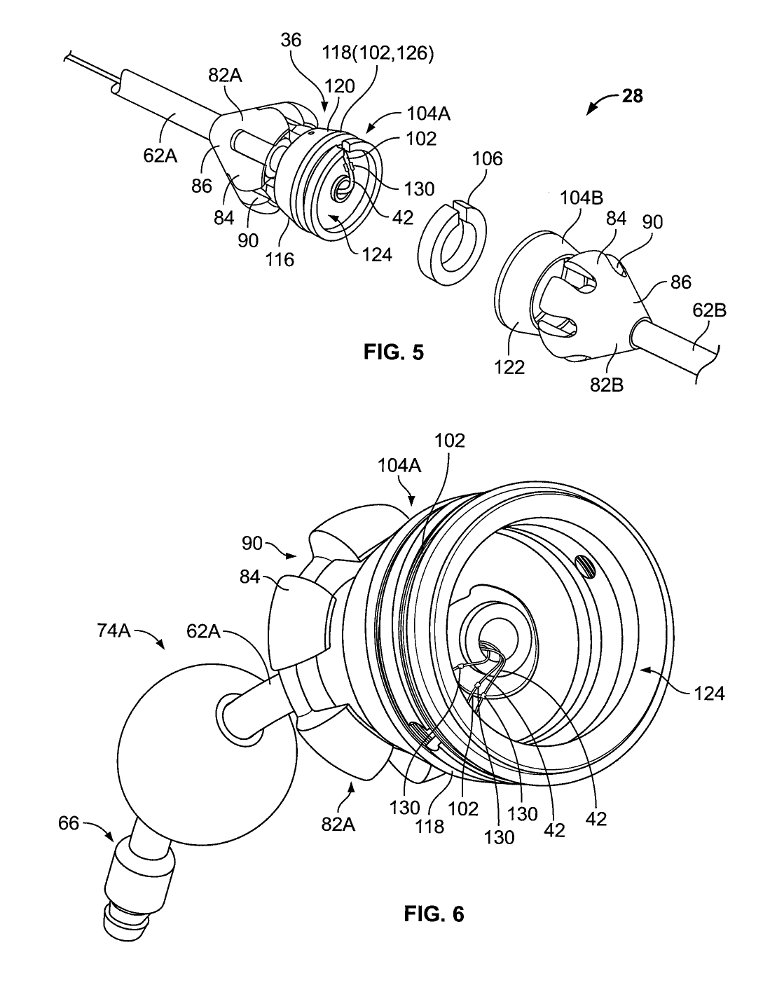

Focusing upon the example probe head shown in FIG. 4, the probe head 28 includes a flexible tube 62. The tube 62 may be made of any suitable flexible material. Some example materials include polymer materials (e.g., flexible polyurethane). The tube 62 is hollow to allow the wire(s) 42 extending within the probe shaft 30 to also extend with the tube 62. The tube 62 actually has two separate segments 62A, 62B (see FIG. 5) that are each joined to the sensor 36. However, for ease of reference, the tube segments are referred to as simply a tube 62.

As mentioned, the probe shaft 30 is attached to the probe head 28. In shown example, the probe shaft 30 is connected to the tube 62. Specifically, a junction fitting 66 (See FIG. 4 in which the probe shaft 30 is shifted over or exploded from the junction fitting 66 to shown more of the junction fitting). In one example, the junction fitting 66 includes a stainless steel ferrule. The junction fitting 66 may be secured to the tube 62 of the probe head 28 via any suitable means (e.g., crimping). With regard to securing the junction fitting 66 to the probe shaft 30, the example shows that the junction fitting 66 has at least one annular barb 70 on an end that extends into the interior of the probe shaft 30. The barb 70 “bites” into the material of the probe shaft 30 at the interior surface of the probe shaft 30 and helps hold the probe shaft 30 onto the junction fitting. Also note that within the shown example, two half-moon shapes 72 are provided (e.g., cut or otherwise formed) into the end of the probe shaft 30. Adhesive (e.g., epoxy) is used to bond the probe shaft 30 onto the junction fitting 66 and thus to the probe head 28. The adhesive (e.g., epoxy) can fill the half-moon shapes 72 and can provide for improved bonds to the junction fitting 66 and locking the probe shaft 30 in place relative to the probe head 28. The junction fitting 66 has an interior bore or passage to permit the wire 42 to extend from the probe shaft 30 and into the tube 62 of the probe head 28. In one embodiment, the junction fitting 66 has a minimized diameter to help reduce resistance to movement of the probe shaft 30 and probe head 28 within the tubular member 12.

Turning again to the probe head 28 (FIGS. 1 and 4), the probe head includes at least one centering bead 74A, 74B affixed to the tube 62. Within the shown example, two centering beads 74A, 74B are provided and the two beads are spaced away from each along the tube 62. The first bead 74A is located a short distance from the junction fitting 66 and is located on a first side of the sensor 36. The second bead 74B is located on an opposite side of the sensor 36 from the first centering bead 74A. Each bead 74A, 74B has a smoothly-curving, arcuate outer surface 76 that is generally rounded. Within the specific shown example, the outer surface 76 is an oblong shape and somewhat egg-shaped with an elongation. The elongation is along the extent of the tube 62. The amount of elongation can be varied. Each centering bead 74A, 74B has a center passageway 78 through which the tube 62 extends. Each bead 74A, 74B may be made of a variety of materials, and the shown example beads are made of a polymer based material (e.g., plastic material—Ultem).

The example probe head 28 also includes at least one centering foot 82 (82A, 82B). Within the shown example, two centering feet 82A, 82B are provided. The centering feet 82A, 82B are spaced away from the centering beads 74A, 74B. Also, the centering feet 82A, 82B are located relatively adjacent to the sensor 36. Specifically, a relatively small space exists between each centering foot 82A, 82B and the sensor 36. Each centering foot 82A, 82B has a center passageway 84 through which the tube 62 extends. Each centering foot 82A, 82B has a general conical shape. A base or wider portion 85 of each centering foot 82A, 82B faces toward the sensor 36 and the tip or narrower portion 86 of each centering foot 82A, 82B is located distal from the sensor 36. At the base 85, each centering foot 82A, 82B has a plurality of petals 88 with open notches 90 being present between adjacent petals 88. The centering feet 82A, 82B may be made of a variety of materials, and the shown example feet are made of a polymer based material (e.g., plastic material—Ultem)

At a tip of the probe head 28 is a nose piece 92. The nose piece 92 has an opening into which the tube 62 extends. A widest portion of the nose piece 92 is at a middle region 94 of the nose piece. From the middle region 94 the nose piece tapers radially inward toward a furthest-most tip portion 96 and as such has a first conic taper. Also, from the middle region 94 the nose piece 92 tapers radially inward as the nose piece extends rearward. Thus, the nose piece 92 has a double conic taper. The nose piece 92 may be made of a variety of materials, and the shown example nose piece is made of a polymer based material (e.g., plastic material—Ultem)

Focusing now upon the sensor 36, the shown example sensor 36 is an eddy current sensor that includes at least one wire winding 102. It is to be noted that the wire windings 102 are visible in FIG. 6 and the ends are visible in FIG. 5, however, the windings 102 are omitted in the other Figures. FIGS. 3-5 do have reference numeral 102, in parenthesis, present to indicate position occupied by the wire windings 102, but for the purpose of illustrating other structures the wire windings have been removed. The windings 102 supported on a bobbin 104 of the sensor 36 and the sensor 36 also includes a magnet 106 (FIG. 5). It is to be appreciated that the sensor 36 may include a variety of structures, components, features, and the like, which may be in addition and/or different from the shown example. The shown example is described, but with the understanding that modifications are possible within the scope of the invention.

Within the shown example, the bobbin 104 has a center section 116 that has a general cylindrical shape and that includes at least one annular groove 118. The wire windings 102 are located within the annular groove 118, but as mentioned the wire windings 102 are omitted from some of the drawing Figures. Within the shown example, each end portion 120, 122 of the bobbin 104 has a truncated cone chamfer shape extending axially and tapering radially inwardly along the axial extent. An interior 124 (FIG. 5) of the bobbin 104 is hollow. The bobbin 104 has an axially-aligned opening at each end and the tube 62 extends to the interior 124 of the bobbin via the openings. The magnet 106 is located within the hollow interior 124 of the bobbin 104.

The bobbin 104 is provided as two, joinable pieces 104A, 104B (FIG. 5) to allow access to the interior 114, but also to seal the interior 124 once joined. The two pieces 104A, 104B can be secured together with adhesive (e.g., epoxy). The bobbin 104 may be made of a variety of materials, and the shown example is made of a polymer based material (e.g., plastic material).

The wire winding 102 of the sensor 36 extends about a periphery of the bobbin 104. In the shown example, the wire winding 102 is located within the annular groove 118. The wire winding 102 within the annular groove may be secured in place/protected via the use of potting material 126 (e.g., epoxy overlaying the wire winding 102 within the annular groove 118). Within the drawing FIGS. 4 and 5, the wire winding 102 and the potting material 126 that is present in the annular groove 118 are not shown for clarity. Within the drawing FIGS. 3-5, the reference numerals 102 and 126 are provided in parenthesis to designate the location within the annular groove 118. Only the ends of the wire winding 102 within the interior 124 are shown in FIG. 5. At least one hole extends from the exterior of the bobbin 104 to the interior 124 of the bobbin and the ends of the wire winding 102 extend to the interior of the bobbin through the hole. The ends of the wire winding 102 are solder-connected 130 to the ends of the wire 42. Attention is directed to FIG. 6, which shows the wire windings 102 within the groove 118 (but without the potting material 126). Also, the presence of the hole through the bobbin 104 to the interior 124 can be appreciated by the visibility of the ends of the wire windings 102 extending into the interior 124. It is to be noted that plural wires 42 are shown solder corrected 130 to plural ends of the wire windings 102. This is merely one example and the numbers may differ, and certainly within the presented scope that the wire may be a plural bundle and there may be plural wire windings.

The provision of the bobbin 104 as two parts, and thus the accessibility of the interior 124 of the hollow bobbin 104, allows direct access to the ends of the wire winding 102 and also to the end of the wire 42. In turn this allows direct electrical connection (e.g., solder connection 130) between the wire winding 102 and the wire 42 (e.g., no intermediary wires or connections are needed). Sensory signals can proceed from the wire winding 102 directly to the wire 42 and in due course to the sensory operation portion 40. The access into the hollow interior 124 and thus the direct electrical connection helps to minimize electrical interference noise by reducing the number of solder junctions. Also, the access into the hollow interior 124 and thus the direct electrical connection allows for the usage of a small diameter for the bobbin 104 and/or the tube 62.

When the bobbin halves 104A, 104B are adhered together, all of the remaining space within the hollow interior 124 of the bobbin 104 that is not otherwise occupied can be filled-up with adhesive (or other material). Such filling can add strength and can help keep the wire ends (i.e., ends of the wire winding 102 and the wire 42) from moving and shifting, which helps reduce noise and extend probe life.

Turning to the movement of the probe head 28 along the tubular member 12, it is to be appreciated that the probe head has several separate features that each aid in such movement with reduced resistance. The two piece bobbin 104 allows the solder connections 130 between the wire 42 and the wire windings 102 inside of the bobbin 104, which helps make the probe head 28 not only mechanically stronger and electrically quieter, but also permits a reduced diameter. The bobbin 104 is a reduced diameter, due in part to the other design features (e.g., direct wire connection). Also, the bobbin 104 has at least one chamfered end portion 120, 122. Such chamfering of the bobbin 104 can provide for increased flexibility of the probe head 28 and the tube 62 thereof. Increased flexibility can yield minimized resistance against movement of the probe head 28. The other portions of the probe head 28 also have been designed to aid in flexibility and minimize resistance. For example, the centering feet 82, the centering beads 74 and the nose piece 92 all have tapering surfaces to aid the components to traverse smaller U-Bend tubing radii.

One problem that can be solved via use of the present invention is possibly avoiding a need to open up both ends of an elongate tubular member for examination. Such a problem solution may be of particular interest to a utility company that generated electricity via use of a steam generator as shown in FIG. 2. Specifically, the present invention may be useful for low row tubing examination of a steam generator. Current technology requires one half of the tubing to be inspected from one end of the generator, and the other half to be inspected from the other end. Such previous techniques may be associated with increased exposure of the operators to radiation and/or takes more setup and test time. By developing a probe that allows for inspection from one side, the utilities will save time, money and radiation exposure.

One technical advantage is the ability for the probe to successfully traverse a small radius tube to do a low row tubing inspection from one side of the generator. Current steam generator probes are not flexible enough and have too much friction between them and the steam generator tubing to do this. Commercially, this is an advantage over existing technology because it will allow the utilities to recognize a significant cost and time savings when doing steam generator inspections.

The present invention provides a useful inspection assembly for a “Low Row” (2.0″ radius tube and greater) U-bend tube of the generator while being durable enough to last for the inspection of approximately 1000 U-Bend tubes.

In recap, the present invention provides several aspects. One example aspect is an inspection assembly for insertion inspection of an elongate tubular member. The inspection assembly includes a probe head including at least one sensor for sensing a characteristic of the elongate tubular member as the probe head is moved internally within the elongate tubular member, the sensor including at least one wire winding. The assembly includes a flexible shaft connected to the probe head and transmitting a motive force to the probe head to move the probe head within the elongate tubular member. The probe head includes a flexible tube, a probe body supporting the sensor and mounted upon the flexible tube, and at least one centering bead mounted upon the flexible tube, the probe body including a center section supporting the at least one wire winding, and the probe body including at least one characteristic to minimize resistance against movement of the probe head along a torturous path within the tubular member.

With regard to other aspects, the characteristic of the probe body to minimize resistance against movement of the probe head along a torturous path within the tubular member may include at least one truncated cone chamfer end adjacent to the center section. The probe body may include two truncated cone chamfer ends. The inspection assembly may further include at least one wire enclosed within the flexible shaft and operatively connected between the sensor and at least one component external to the tubular member for sensory operation of the sensor, and the characteristic of the probe body to minimize resistance against movement of the probe head along a torturous path within the tubular member may include providing the probe body as two separable and attachable parts to allow access for attachment of the at least one wire to the at least one wire winding of the sensor. The inspection assembly may further include adhesive for securing the two parts of the probe body together. The two parts of the probe body may be of a polymer material. The inspection assembly may further include at least one wire enclosed within the flexible shaft and operatively connected between the sensor and at least one component external to the tubular member for sensory operation of the sensor, with the at least one wire being directly connected to the at least one wire winding of the sensor. The probe body may have a hollow interior, ends of the at least one wire winding may extend into the hollow interior and may be corrected to the at least one wire within the hollow interior. The inspection assembly may further including a non-crimp junction fitting between the probe head and the shaft. The junction fitting may include a ferrule with barb and the shaft having a portion extending onto the barbs of the ferrule. The shaft may have crescent-shaped voids at the portion extending onto the barbs of the ferrule, and adhesive may be at least at the location of the crescent-shaped voids.

Another example aspect is an inspection assembly for insertion inspection of an elongate tubular member. The inspection assembly includes a probe head including at least one sensor for sensing a characteristic of the elongate tubular member as the probe head is moved internally within the elongate tubular member, the sensor including at least one wire winding. The assembly also includes a flexible shaft connected to the probe head and transmitting a motive force to the probe head to move the probe head within the elongate tubular member. The probe head includes a flexible tube, a probe body supporting the sensor and mounted upon the flexible tube, and at least one centering bead mounted upon the flexible tube, with the probe body including a center section supporting the at least one wire winding, and the probe body including at least one truncated cone chamfer end adjacent to the center section. The probe body may include two truncated cone chamfer ends. The inspection assembly may further include at least one wire enclosed within the flexible shaft and operatively connected between the sensor and at least one component external to the tubular member for sensory operation of the sensor. The characteristic of the probe body to minimize resistance against movement of the probe head along a torturous path within the tubular member may include providing the probe body as two separable and attachable parts to allow access for attachment of the at least one wire to the at least one wire winding of the sensor. The inspection assembly may further include adhesive for securing the two parts of the probe body together. The two parts of the probe body may be of a polymer material. The inspection assembly may further include at least one wire enclosed within the flexible shaft and operatively connected between the sensor and at least one component external to the tubular member for sensory operation of the sensor, with the at least one wire being directly connected to the at least one wire winding of the sensor. The probe body may has a hollow interior, with ends of the at least one wire winding extend into the hollow interior and that are corrected to the at least one wire within the hollow interior. The inspection assembly may further include a non-crimp junction fitting between the probe head and the shaft. The junction fitting may include a ferrule with barbs. The shaft may have a portion extending onto the barbs of the ferrule. The shaft may have crescent-shaped voids at the portion extending onto the barbs of the ferrule, and adhesive may be at least at the location of the crescent-shaped voids.

Another example aspect is an inspection assembly for insertion inspection of an elongate tubular member. The inspection assembly includes a probe head that includes at least one sensor for sensing a characteristic of the elongate tubular member as the probe head is moved internally within the elongate tubular member, the sensor including at least one wire winding. The assembly also includes a flexible shaft connected to the probe head and transmitting a motive force to the probe head to move the probe head within the elongate tubular member, the shaft including at least one wire operatively connected between the sensor and at least one component external to the elongate tubular member for sensory operation of the sensor. The probe head includes a flexible tube, a probe body supporting the sensor and mounted upon the flexible tube, and at least one centering bead mounted upon the flexible tube, the probe body including a center section supporting the at least one wire winding, and the probe body being provided as two separable and attachable parts to allow access for direct attachment of the at least one wire to the at least one wire winding of the sensor. The tubular member may include at least one truncated cone chamfer end adjacent to the center section. The probe body may have a hollow interior, with ends of the at least one wire winding extend into the hollow interior and are corrected to the at least one wire within the hollow interior.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed:

1. An inspection assembly for insertion inspection of an elongate tubular member, the inspection assembly including:
a probe head including at least one sensor for sensing a characteristic of the elongate tubular member as the probe head is moved internally within the elongate tubular member, the sensor including at least one wire winding; and
a flexible shaft connected to the probe head and transmitting a motive force to the probe head to move the probe head within the elongate tubular member;
wherein the probe head includes a flexible tube, a probe body supporting the sensor and mounted upon the flexible tube, and at least one centering bead mounted upon the flexible tube, the probe body including a center section supporting the at least one wire winding, and the probe body including at least one characteristic to minimize resistance against movement of the probe head along a torturous path within the tubular member.

2. An inspection assembly as set forth in claim 1, wherein the characteristic of the probe body to minimize resistance against movement of the probe head along a torturous path within the tubular member includes at least one truncated cone chamfer end adjacent to the center section.

3. An inspection assembly as set forth in claim 2, wherein the probe body includes two truncated cone chamfer ends.

4. An inspection assembly as set forth in claim 1, further including at least one wire enclosed within the flexible shaft and operatively connected between the sensor and at least one component external to the tubular member for sensory operation of the sensor, and the characteristic of the probe body to minimize resistance against movement of the probe head along a torturous path within the tubular member includes providing the probe body as two separable and attachable parts to allow access for attachment of the at least one wire to the at least one wire winding of the sensor.

5. An inspection assembly as set forth in claim 4, further including adhesive for securing the two parts of the probe body together.

6. An inspection assembly as set forth in claim 5, wherein the two parts of the probe body are of a polymer material.

7. An inspection assembly as set forth in claim 1, further including at least one wire enclosed within the flexible shaft and operatively connected between the sensor and at least one component external to the tubular member for sensory operation of the sensor, the at least one wire being directly connected to the at least one wire winding of the sensor.

8. An inspection assembly as set forth in claim 7, wherein the probe body has a hollow interior, ends of the at least one wire winding extend into the hollow interior and are corrected to the at least one wire within the hollow interior.

9. An inspection assembly as set forth in claim 1, further including a non-crimp junction fitting between the probe head and the shaft, the junction fitting including a ferrule with barbs, the shaft having a portion extending onto the barbs of the ferrule, the shaft having crescent-shaped voids at the portion extending onto the barbs of the ferrule, and adhesive at least at the location of the crescent-shaped voids.

10. An inspection assembly for insertion inspection of an elongate tubular member, the inspection assembly including:
a probe head including at least one sensor for sensing a characteristic of the elongate tubular member as the probe head is moved internally within the elongate tubular member, the sensor including at least one wire winding; and
a flexible shaft connected to the probe head and transmitting a motive force to the probe head to move the probe head within the elongate tubular member;
wherein the probe head includes a flexible tube, a probe body supporting the sensor and mounted upon the flexible tube, and at least one centering bead mounted upon the flexible tube, the probe body including a center section supporting the at least one wire winding, and the probe body including at least one truncated cone chamfer end adjacent to the center section.

11. An inspection assembly as set forth in claim 10, wherein the probe body includes two truncated cone chamfer ends.

12. An inspection assembly as set forth in claim 10, further including at least one wire enclosed within the flexible shaft and operatively connected between the sensor and at least one component external to the tubular member for sensory operation of the sensor, and the characteristic of the probe body to minimize resistance against movement of the probe head along a torturous path within the tubular member includes providing the probe body as two separable and attachable parts to allow access for attachment of the at least one wire to the at least one wire winding of the sensor.

13. An inspection assembly as set forth in claim 12, further including adhesive for securing the two parts of the probe body together.

14. An inspection assembly as set forth in claim 13, wherein the two parts of the probe body are of a polymer material.

15. An inspection assembly as set forth in claim 10, further including at least one wire enclosed within the flexible shaft and operatively connected between the sensor and at least one component external to the tubular member for sensory operation of the sensor, the at least one wire being directly connected to the at least one wire winding of the sensor.

16. An inspection assembly as set forth in claim 15, wherein the probe body has a hollow interior, ends of the at least one wire winding extend into the hollow interior and are corrected to the at least one wire within the hollow interior.

17. An inspection assembly as set forth in claim 10, further including a non-crimp junction fitting between the probe head and the shaft, the junction fitting including a ferrule with barbs, the shaft having a portion extending onto the barbs of the ferrule, the shaft having crescent-shaped voids at the portion extending onto the barbs of the ferrule, and adhesive at least at the location of the crescent-shaped voids.

18. An inspection assembly for insertion inspection of an elongate tubular member, the inspection assembly including:
a probe head including at least one sensor for sensing a characteristic of the elongate tubular member as the probe head is moved internally within the elongate tubular member, the sensor including at least one wire winding; and
a flexible shaft connected to the probe head and transmitting a motive force to the probe head to move the probe head within the elongate tubular member, the shaft including at least one wire operatively connected between the sensor and at least one component external to the elongate tubular member for sensory operation of the sensor;
wherein the probe head includes a flexible tube, a probe body supporting the sensor and mounted upon the flexible tube, and at least one centering bead mounted upon the flexible tube, the probe body including a center section supporting the at least one wire winding, and the probe body being provided as two separable and attachable parts to allow access for direct attachment of the at least one wire to the at least one wire winding of the sensor.

19. An inspection assembly as set forth in claim 18, wherein the tubular member includes at least one truncated cone chamfer end adjacent to the center section.

20. An inspection assembly as set forth in claim 18, wherein the probe body has a hollow interior, ends of the at least one wire winding extend into the hollow interior and are corrected to the at least one wire within the hollow interior.
